(19) United States
(12) Patent Application Publication
(10) Pub. No.: US 2022/0411345 A1
(43) Pub. Date: Dec. 29, 2022

(54) NITRIFICATION AND VOLATILIZATION INHIBITOR FORMULATIONS THAT INCLUDE CARBOXYLATED POLYMERS AND METHODS OF USE THEREOF

(71) Applicant: NANOCHEM SOLUTIONS, INC., Bedford Park, IL (US)

(72) Inventors: George MURRAY, Lebanon, IN (US); Grace FAN, Naperville, IL (US); Joseph FAN, Naperville, IL (US); Dan O'BRIEN, Brentwood Bay (CA); Alex POLOZOV, Naperville, IL (US)

(21) Appl. No.: 17/624,288

(22) PCT Filed: Jul. 2, 2020
(86) PCT No.: PCT/US20/40722

§ 371 Date: Dec. 31, 2021

Related U.S. Application Data
(60) Provisional application No. 62/869,973, filed on Jul. 2, 2019.

(51) Int. Cl. C05G 3/90; C05C 9/00; C05B 17/00; C05C 11/00

(52) U.S. Cl. CPC C05G 3/90; C05C 9/005; C05B 17/00; C05C 11/00

(57) ABSTRACT

A compositions of new nitrification/volatilization inhibitor products that also contain a liquid solvent, a carboxylated polymer component, a nitrification inhibitor, and/or a volatilization inhibitor that is either uniformly applied to granular fertilizers (containing nitrogen or not containing nitrogen), or to a liquid fertilizer product in a tank. According to an aspect of the invention, there is provided a product comprising: from about 1-5 parts liquid solvent, from about 0.5-5 parts carboxylated polymer, from about 0.5-5 parts nitrification inhibitor, from 0.5-5 parts volatilization inhibitor, and optionally from about 0-5 parts sugar alcohol.

### CROSS-REFERENCE TO RELATED APPLICATION

This patent application claims priority to U.S. Provisional Application 62/869,973 filed Jul. 2, 2019, the disclosure of which is considered part of the disclosure of this application and is hereby incorporated by reference in its entirety.

### FIELD OF THE INVENTION

This invention relates generally to a liquid composition, comprising a solvent and a carboxylated polymer structure, optionally combined with one or more additional nitrification and/or volatilization inhibitors.

### BACKGROUND

In the chemical and agricultural industry, it is known that nitrification and volatilization is an issue that affects both the environment, as well as the yield of crops. When a nitrogen source is applied to a crop, a large amount of the nitrogen is either lost due to ammonia volatilization (especially in alkaline soils), nitrate leaching, or loss due to nitrous oxide emissions. Ammonia volatilization can lead to an enhanced deposition of acidic pollutants. Nitrous acid is a potent greenhouse gas that is estimated to have approximately 300 times the amount of global warming potential than that of carbon dioxide. Nitrate leaching leads to algal blooms in bodies of water, leading to eutrophication and the negative impact on the flora and fauna and quality of the water in general.

One way to limit this loss is to apply one (or several) nitrification and/or volatilization inhibitors during the application of the nitrogen. Nitrification inhibitors work to limit the effectiveness of the organisms responsible for the nitrification—chiefly ammonia-oxidizing bacteria (AOB), and ammonia-oxidizing archaea (AOA). If one can limit the production of nitrates from the urea, or ammonium-based nitrogen fertilizer that is applied, one can limit the nitrate leaching and the production of nitrous oxide emissions, while simultaneously allowing the plant access to a greater percentage of the nitrogen that is applied. Soil pH, moisture, temperature, texture, and organic matter composition are all variables that control how effective a specific nitrification inhibitor will be. An issue endemic to all nitrification inhibitors is the short-term increase of the ammonium concentration in the soil. Studies have shown that the ammonium increase can cause the displacement of other cations in the soil—specifically potassium (K⁺), calcium (Ca²⁺) and magnesium (Mg²⁺). While the temporary nitrogen content is increased for the plants, the available potassium, calcium, and magnesium content can decrease—which could negatively impact the overall yield of the plant. This is possibly why some trials do not show a net benefit from applying a nitrification inhibitor when one considers the cost of the inhibitor.

Specific carboxylated polymer structures can be large enough to persist in the soil for a meaningful period of time and have a charge density high enough to complex or adsorb cationic minerals in the soil. One such carboxylated polymer, polyaspartate, has been shown in thousands of studies to improve total yield compared to controls by increasing nutrient uptake—including nitrogen. Recent experimentation has shown that polyaspartate in general reduces the volatilization of ammonium by adsorbing the ammonium molecule, thereby providing stability, and preventing its immediate availability to ammonia-oxidizing organisms. The anionic sites on the polyaspartate polymer persist in the soil, and exchange nutrients as the concentrations rise and fall. By combining a nitrification inhibitor with a carboxylated polymer that is designed to increase nutrient uptake in plants, one can increase the nitrogen that's available to plants, while also increasing availability and stability of other nutrients in the soil that might have otherwise been leached away.

NBPT is an example of an effective volatilization inhibitor that temporarily reduces the activity of the urease enzyme, which slows the rate of urea hydrolysis. Once the conversion does happen though, urea is converted into ammonium bicarbonate. This increases the pH immediately surrounding the conversion site, which leads to ammonia volatilization. Pairing a carboxylated polymer with NBPT would allow the carboxylated polymer to adsorb the ammonium along with cationic nutrients that might other precipitate out of solution in the presence of the higher pH. This would help to prevent the ammonia volatilization as well as increase the uptake of other nutrients into the plant.

Dicyandiamide (DCD) and dimethypyrazoles have been shown to reduce the nitrification of nitrogen fertilizers in the soil and are examples of nitrification inhibitors. While the performance of DCD and dimethylpyrazoles are comparable in certain agronomic conditions, the benefit is that the dimethylpyrazoles work at a lower rate than that of DCD. On the other hand, DCD has been shown to work in a wider variety of fields conditions. With either molecule, one can include a carboxylated polymer, and apply it onto a granular fertilizer with enough of both the nitrification inhibitor as well as the carboxylated polymer to be effective in the field. There exists a need for a composition to reduce nitrification and nitrogen loss in the field without negatively impact the overall yield of the plants.

### BRIEF SUMMARY OF THE INVENTION

In one aspect, this disclosure is related to a composition including a liquid solvent, a carboxylated polymer component, and a nitrification/volatilization inhibitor (“NVI”) component. The composition of the present disclosure can be applied uniformly to granular fertilizers that may or may not contain nitrogen, or similarly can be a liquid fertilizer product in a tank. In some exemplary embodiments, the composition of the present disclosure can further include a sugar alcohol component. According to an exemplary embodiment of the present disclosure the nitrification inhibiting composition can include about 1 to about 5 parts liquid solvent, from about 0.5-5 parts carboxylated polymer, from about 0.5-5 parts nitrification/volatilization inhibitor, and from about 0-5 parts sugar alcohol. In some exemplary embodiments, the sugar alcohol component can be used as a solvent or co-solvent.

In another aspect, this disclosure is related to a composition including about 5-40% by weight of a volatilization inhibitor component, about 5-40% by weight of a nitrification inhibitor component, about 5-50% by weight of a carboxylated polymer, about 15-60% by weight of a solvent component, and about 0-75% by weight of a sugar alcohol component.

In another aspect, this disclosure is related to a method of inhibiting nitrification and/or volatilization and nitrogen loss in an environment by applying a composition to the environment, wherein the composition includes a liquid solvent, a carboxylated polymer component, and a nitrification inhibitor component.

In another aspect, this disclosure is related to a composition for inhibiting nitrification and volatilization in an environment including a granular material and a coating component, wherein the composition coating is applied to the granular material between 1 to 6 liters of composition per metric ton of the granular material. The granular material can be urea and the coating component can include a solvent between 15-70% by weight, one or more carboxylated polymers between 5-50% by weight, one or more nitrification inhibitor components between 5-40% by weight, and/or one or more volatilization inhibitor components between 5-40% by weight.

In yet another aspect, this disclosure is related to method of treating an environment to inhibit nitrification and volatilization including preparing a composition comprising a solvent between 15-70% by weight, one or more carboxylated polymers between 5-50% by weight, a nitrification inhibitor component between 5-40% by weight, and a volatilization inhibitor component between 5-40% by weight. The composition can then be applied to a granular material at a ratio of between 1-6 liters of the composition per metric ton of the granular material to produce a coated granular material. The coated granular material can then be applied to the environment.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The present disclosure provides a nitrification inhibitor composition including a solvent component, a carboxylated polymer component, and a nitrification inhibitor component. The nitrification inhibitor composition can be applied uniformly to granular fertilizers that may or may not contain nitrogen, or similarly can be a liquid fertilizer product in a tank. In some exemplary embodiments, the composition can further include a sugar alcohol component. Some exemplary embodiments of the composition of the present disclosure can include about 5-40% by weight of a volatilization inhibitor component, about 5-40% by weight of a nitrification inhibitor component, about 5-50% by weight of a carboxylated polymer, about 15-70% by weight of a solvent component, and about 0-75% by weight of a sugar alcohol component.

In some exemplary embodiments, the solvent source can include by way of example, but not limited to: water, glycerol, tetrahydrofuran, dimethylacetamide, N-methyl-2-pyrrolidone, hexafluoroisopropanol, butylated hydroxytoluene, dimethylformamide, dimethylacetamide, dimethyl sufloxide, sodium trifluoroacetate, triethylamine, ethanolamine, diethanolamine, triethanolamine, ethylene glycol, propylene glycol, triethylene glycol, triethyl phosphate, eucalyptol, dicarbonyls (dimethyl carbonate, etc.) and mixtures thereof. In some exemplary embodiments, the solvent can include about 6 parts dimethyl sulfoxide, and the carboxylated polymer can be about 4 parts polysuccinimide. In other exemplary embodiments, the solvent can include about 3.1 parts glycerol, about 2 parts water, and the carboxylated polymer can be about 4.9 parts spray-dried potassium polyaspartate. In some exemplary embodiments, the solvent can be a liquid. In some exemplary embodiment, the solvent component can be about 15-70% by weight of the composition or about 20-65% by weight of the composition of the present disclosure. In some exemplary embodiments, the solvent can be a mixture of one or more solvents, such as between about 25-35% by weight of glycerol and about 15-25% by weight of water.

In some exemplary embodiments of the composition of the present disclosure a carboxylated polymer component can include by way of example, but not limited to: carboxylated polymers containing an amine group (such as polyaspartate, polyglutamate, polyanhydroaspartic acid, among others), carboxylated polymers not containing an amine group (such as polyepoxysuccinic acid and others), or polymer salts such as a polyaspartate salt. The salts can include any suitable form, including potassium, sodium, ammonium, ethanolamine, L-arginine, among others. In some exemplary embodiments of the composition can include the carboxylated polymer at about 5-50% by weight of the composition, or about 10-25% by weight of the composition, or about 5-20% by weight of the composition. Some exemplary embodiments can use polysuccinimide acid or a polyaspartate salt as the carboxylated polymer component. In some exemplary embodiments of the composition can include the carboxylated polymer at about 5-50% by weight of the composition or about 5-20% by weight of the composition. In other exemplary embodiments, the carboxylated polymer can be between about 45-55% by weight of potassium polyaspartate.

The nitrification and/or volatilization inhibitor (“NVI”) component can include by way of example, but not limited to: 3,4-dimethylpyrazole, 3,4-dimethylpyrazole phosphate, 3,4-dimethylpyrazole sulfate, 3,4-dimethylpyrazole nitrate, 3,4-dimethylpyrazole chloride, 3,4-dimethylpyrazole succinate, 3,4-dimethylpyrazole aspartate, 3-4-dimethylpyrazole polyaspartate, 3,5-dimethylpyrazole, 3,5-dimethylpyrazole phosphate, 3,5-dimethylpyrazole sulfate, 3,5-dimethylpyrazole nitrate, 3,5-dimethylpyrazole chloride, 3,5-dimethylpyrazole succinate, 3,5-dimethylpyrazole aspartate, 3,5-dimethylpyrazole polyaspartate, dicyandiamide (DCD), N-(n-Butyl) thiophosphoric triamide (NBPT), phenylphosphorodiamidate (PPD), hydroquinine, neem oil, neem cake, p-benzoquinione, 1,4-benzoquinone, catechol, ammonium thiosulfate, potassium thiosulfate, boric acid, sodium tetraborate pentahydrate, sodium tetraborate decahydrate, anhydrous sodium tetraborate, copper (I) oxide, copper (II) oxide, copper hydroxide, copper carbonate, copper sulfate (and its respective hydrates), copper chloride, copper nitrate, copper EDTA, copper DTPA, copper EDDS, copper IDS, copper citrate, copper-amino acid chelates, cobalt oxide, cobalt hydroxide, cobalt carbonate, cobalt sulfate, cobalt chloride, cobalt nitrate, cobalt EDTA, cobalt DTPA, cobalt EDDS, cobalt IDS, cobalt citrate, cobalt-amino acid chelates, zinc oxide, zinc hydroxide, zinc carbonate, zinc sulfate, zinc chloride, zinc nitrate, zinc EDTA, zinc DTPA, zinc EDDS, zinc IDS, zinc citrate, zinc-amino acid chelates or mixtures thereof.

In some exemplary embodiments, the NVI component may include two individual components, one that functions as a nitrification inhibitor component and a second component which functions as a volatilization inhibitor component. Some exemplary embodiments of the composition of the present disclosure can include about 5-40% by weight of a volatilization inhibitor component, about 5-40% by weight of a nitrification inhibitor component. Some exemplary embodiments can have nitrification component of DCD at about 5-25% by weight and a volatilization inhibitor component of NBPT at about 5-25% by weight of the composition.

In some exemplary embodiments, the composition of the present disclosure can optionally include a sugar alcohol component. The sugar alcohol component may be for example, but by no means limited to: erythritol, arabitol, xylitol, ribitol, mannitol, sorbitol, galactitol, fucitol, iditol, inositol, volemitol, isomalt, maltitol, lactitol, maltotriitol, maltotetraitol, polyglycitol, and mixtures thereof. Some embodiments of the composition of the preset disclosure can have a sugar alcohol at about 0-75% by weight of the composition. One embodiment can use glycerol as the sugar alcohol component at about 0-45% by weight of the composition. In some other exemplary embodiments, the composition can further include additional components, such as a viscosity modifier. In some exemplary embodiments, the composition can be glycerol or DMSO, the carboxlated polymer can either polysuccinimide or polyaspartate, the volatilization inhibitor component is NPBT and the nitrification inhibitor component is DCD.

One or more exemplary embodiment of the composition of the present disclosure can be applied to environment in either a liquid form or first applied to a granular material, such as a granular fertilizer or other environment, before being applied to an environment such as soil or vegetation. The granular material can be any suitable material such as clay or granular fertilizers that may or may not contain nitrogen. One exemplary embodiment can use granular urea ammonium nitrate or urea. In some exemplary embodiments, the composition of the present disclosure can be applied to granular material as a coating component at volume of about 1 to about 14 or about 2 to about 8, about 4 liters or about 2 liters of the composition coating component per metric ton of the granular material. In some embodiments, the granular material can be a granular fertilizer, such as urea.

In some exemplary embodiments, the composition of the present disclosure can be applied in the same amount as traditionally applied to the environment as if a user was applying a traditional amount of fertilizer. In some exemplary embodiments, between about 100 kgs of coated urea product per hectare to about 500 kgs of hectare. When you spray 4 L of a solution having between about 10-15% by weight of DCD, 10-15% by weight of NBPT, and between 10-20% by weight of polyaspartate, and the product weighs approximately 1.34 kg/L, you end up with about 47 grams of DCD and NBPT and 36 grams polyaspartate at 150 kgs per hectare of fertilizer.

In one exemplary embodiment, a mixture of glycerol and DMSO can be mixed together using any suitable means. Because DMSO is miscible in glycerol and has a similar viscosity to water (1.996 cP and 1 cP respectively), it can act as a viscosity modifier, as well as solvent. In one exemplary embodiment, polysuccinimide can be used as a polymer component and can additionally be used to modify the pH. In some embodiments, the polymer component, such as polysuccinimide, can be chosen due to its also solubility in the particular solvent component. In this example, polysuccinimide can be used as the polymer component as it is soluble in glycerol and DMSO—with the nitrification inhibitor component also being soluble in the DMSO. In this exemplary embodiment, the composition can be produced without any water, which can allow a larger amount of the material to be applied to granular fertilizer or other environment, including but not limited to soil or vegetation.

In another exemplary embodiment, between about 380 to about 400 grams of DMSO can be added to about a 500 mL beaker. The mixture can be agitated at about 500 revolutions per minute, between about 80 and 100 grams of dicyandiamide (DCD) can be added to the beaker. Minimal heat of around 40 degrees C. can be generated and maintain to assist the DCD into the solution of DMSO. Once the DCD is in solution, between about 80 and 100 grams of N-(n-butyl) thiophosphoric triamide can be added to the beaker. Once NBPT is in solution the polysuccinimide (93% purity) can be added to the solution. The polysuccinimide will generate heat as it goes into solution and should be added slowly to ensure that the temperature of the solution remains around 40 degrees C. The finished mixture is approximately 13% by weight DCD, 13% by weight NBPT, 13% by weight polysuccinimide, and about 57.5% DMSO by weight. The additional components of the mixture may include one or more impurities or water. In some exemplary embodiments, if water remains the water can be evaporated or boiled off during the mixing to increase the concentrations of the remaining components. This composition can then be added to a liquid solution of nitrogen, such as urea ammonium nitrate at 2-12 L per metric ton, or to granular fertilizer at 2-4 L per metric ton.

In another example, one 500-mL beaker and one 1000-mL beaker is needed. In the 1000 mL-beaker, 274.1 grams of glycerol is added, placed onto a hot plate, and heated to 80 degrees C. Following this 80.9 grams of a spray-dried potassium polyaspartate polymer (93% purity) is added to glycerol and agitated under standard agitation at 500 revolutions per minute. This mixture should be allowed to mix until the potassium polyaspartate is completely in solution.

In the 1000-mL beaker, about 195 grams of DMSO is added, and the beaker is placed on a hot plate under a standard agitation of 500 revolutions per minute. The DMSO is heated to 40 degrees C. and maintained throughout the mix. Once DMSO is heated to 40 degrees C., about 98.8 grams of dicyandiamide (DCD) is added and mixed until it is in solution. Following this, about 98.8 grams of N-(n-butyl) thiophosphoric triamide (NBPT) is added and mixed until it is in solution. Once all of the inputs are completely in solution, the contents of the 500-mL beaker are added into the mixture.

In one exemplary embodiment, a finished composition can be an admixture of potassium polyaspartate (about 10% by weight), DCD (about 13% by weight), and NBPT (about 13% by weight) in a cosolvent system consisting of glycerol and DMSO (about 60% by weight). The product could be applied to granular fertilizers at a rate of about 1-6 L per metric ton. Exemplary embodiments of the composition of the present disclosure can be applied to a granular material, such as fertilizer at about 4 L of the composition per metric ton of the granular material. In one exemplary embodiment, the granular material can be urea. The composition can be applied to the granular material using any suitable means. In one exemplary embodiment, the liquid nitrification and volatilization inhibitor composition of the present disclosure can be applied using a sprayer whereby about 100 grams of the composition can be sprayed onto about 25 kgs of the granular material in a mixer. In some embodiments, the ration of coating component of the composition applied to the granular material can be between about 1:100 to about 1:500. The composition is allowed to dry on the granular material as it is being mixed for about 30 minutes. After the composition is sprayed, mixed, and dried onto the granular material, the final product can be a coated granule that contains the nitrification and volatilization inhibitor composition. In one exemplary embodiment, the final product can include urea granules coated with the composition including polyaspartate, DCD, and NBPT. In some embodiments, the final coated urea granule can contain between about 0.1 to about 0.2 kg of DCD per metric ton of urea granule, between about 0.1 to about 0.2 kg by weight of NPBT per metric ton of urea granules, and between about 0.1 to about 0.2 kg by weight of polyaspartate per metric ton of urea granules.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A composition to inhibit nitrification and volatilization in an environment comprising:
a solvent between 15-70% by weight;
one or more carboxylated polymers between 5-50% by weight; and
at least one or more of the following:
a nitrification inhibitor components between 5-40% by weight or one or more volatilization inhibitor components between 5-40% by weight.

2. The composition of claim 1, further comprising a sugar alcohol component between 0-75% by weight.

3. The composition of claim 1 in which the solvent is selected from one or more of water, glycerol, tetrahydrofuran, dimethylacetamide, N-methyl-2-pyrrolidone, hexafluoroisopropanol, butylated hydroxytoluene, dimethylformamide, dimethylacetamide, dimethyl sufloxide, sodium trifluoroacetate, triethylamine, ethanolamine, diethanolamine, triethanolamine, ethylene glycol, propylene glycol, triethylene glycol, triethyl phosphate, eucalyptol, or dicarbonyls (dimethyl carbonate, etc.), and the carboxylated polymers are selected from one or more of carboxylated polymers containing an amine group (such as polyaspartate, polyglutamate, polyanhydroaspartic acid etc.), carboxylated polymers not containing an amine group (such as polyepoxysuccinic acid, etc.).

4. The composition of claim 1 in which the solvent is between 40-60% by weight of glycerol and DMSO, and the carboxylated polymer is between 5 and 20% by weight polysuccinimide.

5. The composition of claim 1 in which the solvents are between about 25-35% by weight of glycerol and 15-25% by weight of water, and the carboxylated polymer is between about 45 and 55% by weight of potassium polyaspartate.

6. The composition of claim 4, wherein the nitrification inhibitor component is dicyandiamide (DCD) and the volatilization component is N-(n-butyl) thiophosphoric triamide NBPT.

7. The composition of claim 6, wherein DCD is between 5-25% by weight and the NBPT is between 5-25% by weight of the composition.

8. The composition of claim 5 in which the nitrification and volatilization inhibitor components are selected from one or more of water, glycerol, tetrahydrofuran, dimethylacetamide, N-methyl-2-pyrrolidone, hexafluoroisopropanol, butylated hydroxytoluene, dimethylformamide, dimethylacetamide, dimethyl sufloxide, sodium trifluoroacetate, triethylamine, ethanolamine, diethanolamine, triethanolamine, ethylene glycol, propylene glycol, triethylene glycol, triethyl phosphate, or eucalyptol, and the carboxylated polymers are selected from one or more of carboxylated polymers containing an amine group (such as polyaspartate, polyglutamate, polyanhydroaspartic acid etc.), carboxylated polymers not containing an amine group (such as polyepoxysuccinic acid, etc.), and the nitrification inhibitors are selected from 3,4-dimethylpyrazole, 3,4-dimethylpyrazole phosphate (DMPP), 3,4-dimethylpyrazole sulfate, 3,4-dimethylpyrazole nitrate, 3,4-dimethylpyrazole chloride, 3,4-dimethylpyrazole succinate, 3,4-dimethylpyrazole aspartate, 3-4-dimethylpyrazole polyaspartate, 3,5-dimethylpyrazole, 3,5-dimethylpyrazole phosphate, 3,5-dimethylpyrazole sulfate, 3,5-dimethylpyrazole nitrate, 3,5-dimethylpyrazole chloride, 3,5-dimethylpyrazole succinate, 3,5-dimethylpyrazole aspartate, 3,5-dimethylpyrazole polyaspartate, dicyandiamide (DCD), N-(n-Butyl) thiophosphoric triamide (NBPT), phenylphosphorodiamidate (PPD), hydroquinine, neem oil, neem cake, p-benzoquinione, 1,4-benzoquinone, catechol, ammonium thiosulfate, potassium thiosulfate, boric acid, sodium tetraborate pentahydrate, sodium tetraborate decahydrate, anhydrous sodium tetraborate, copper (I) oxide, copper (II) oxide, copper hydroxide, copper carbonate, copper sulfate (and its respective hydrates), copper chloride, copper nitrate, copper EDTA, copper DTPA, copper EDDS, copper IDS, copper citrate, copper-amino acid chelates, cobalt oxide, cobalt hydroxide, cobalt carbonate, cobalt sulfate, cobalt chloride, cobalt nitrate, cobalt EDTA, cobalt DTPA, cobalt EDDS, cobalt IDS, cobalt citrate, cobalt-amino acid chelates, zinc oxide, zinc hydroxide, zinc carbonate, zinc sulfate, zinc chloride, zinc nitrate, zinc EDTA, zinc DTPA, zinc EDDS, zinc IDS, zinc citrate, or zinc-amino acid chelates.

9. The composition in claim 8 wherein the solvent is between 20-65% of the composition, the carboxylated polymer is between 10-25% of the composition, the volatilization inhibitor component is between 10-20% of the composition and the nitrification inhibitor component is between 10-20% of the composition.

10. The composition of claim 9, wherein the solvent is solvent is DMSO, the carboxylated polymer is polysuccinimide, the volatilization inhibitor component is NPBT and the nitrification inhibitor component is DMPP.

11. A composition for inhibiting nitrification and volatilization in an environment comprising:
a granular material; and
a coating component, wherein the coating component is applied to the granular material between 1 to 6 liters of the coating component per metric ton of the granular material.

12. The composition of claim 11, wherein the granular material is urea.

13. The composition of claim 12, wherein the coating component is comprised of one or more solvents between 15-70% by weight, one or more carboxylated polymers between 5-50% by weight, a nitrification inhibitor component between 5-40% by weight, and a volatilization inhibitor component between 5-40% by weight.

14. The composition of claim 13, wherein the coating component further includes a sugar alcohol component between 0-75% by weight.

15. The composition of claim 13, wherein the solvent is either glycerol or DMSO, the carboxylated polymer is either polysuccinimide or polyaspartate, the volatilization inhibitor component is NPBT and the nitrification inhibitor component is DCD.

16. The composition of claim 13, wherein the composition is applied at a ratio of about 2 liters of composition per metric ton of granule material.

17. A method of treating an environment to inhibit nitrification and volatilization comprising:
preparing a composition comprising a solvent between 15-70% by weight, one or more carboxylated polymers between 5-50% by weight, a nitrification inhibitor component between 5-40% by weight, and a volatilization inhibitor component between 5-40% by weight;
applying the composition to a granular material at a ratio of between 1-6 liters of the composition per metric ton of the granular material to produce a coated granular material; and
applying the coated granular material to the environment.

18. The method of claim 17, wherein the solvent is either glycerol or DMSO, the carboxylated polymer is either polysuccinimide or polyaspartate, the volatilization inhibitor component is NPBT and the nitrification inhibitor component is DCD.

19. The method of claim 17, wherein the coated granular material is applied to the environment at between 100 kgs of coated granular material per hectare to about 500 kgs of coated granular material per hectare.

20. The method of claim 18, wherein the granular material is urea.
